(19) United States
(12) Patent Application Publication
(10) Pub. No.: US 2025/0123523 A1
(43) Pub. Date: Apr. 17, 2025

(54) DISPLAY DEVICE

(71) Applicant: Japan Display Inc., Tokyo (JP)

(72) Inventors: Akihiko SAITOH, Tokyo (JP); Hiroyuki ABE, Tokyo (JP)

(73) Assignee: Japan Display Inc., Tokyo (JP)

(21) Appl. No.: 18/903,200

(22) Filed: Oct. 1, 2024

(30) Foreign Application Priority Data
Oct. 13, 2023 (JP) 2023-177202

(51) Int. Cl. G02F 1/1362; G02F 1/1368

(52) U.S. Cl. CPC G02F 1/136286; G02F 1/136209; G02F 1/1368

(57) ABSTRACT

A display device includes a display region arranged with a plurality of pixels on an insulating surface, and a terminal region with a plurality of output terminals electrically connected to the plurality of pixels in a peripheral region surrounding the display region, wherein a first output terminal and a second output terminal of the plurality of output terminals are staggered, the first output terminal includes a first conductive layer, a second conductive layer, and a third conductive layer electrically connected to each other, the second output terminal includes a fourth conductive layer, a fifth conductive layer, and a sixth conductive layer electrically connected to each other, the second conductive layer has a first region extending toward the display region and functioning as a first wiring, and the fourth conductive layer has a second region extending toward the display region and functioning as a second wiring.

### CROSS-REFERENCE TO RELATED APPLICATIONS

This application claims the benefit of priority to Japanese Patent Application No. 2023-177202, filed on Oct. 13, 2023, the entire contents of which are incorporated herein by reference.

### FIELD

An embodiment of the present invention relates to a display device. In particular, the present invention relates to a display device with a novel configuration that efficiently arranges a connection terminal and a wiring that are electrically connected to an IC chip.

### BACKGROUND

In recent years, an increase in the number of pixels is desired to display high-definition images on display devices for VR applications used in head-mounted displays and other applications (e.g., Japanese laid-open patent publication 2022-153055). On the other hand, as the number of pixels increases, the number of signal lines for supplying image data corresponding to each pixel increases. As a result, the area of the signal line in the display device increases and the size of the display device increases.

Furthermore, in recent years, a transistor using an oxide semiconductor for a channel has been developed. A transistor using an oxide semiconductor for a channel has a simple configuration and can be formed using a low-temperature process, similar to a transistor using amorphous silicon for the channel. The transistor using the oxide semiconductor for the channel has higher mobility and an extremely lower off-state current than the transistor using amorphous silicon for the channel. In the case where the transistor can be formed in a simple configuration and in a low-temperature process, the manufacturing cost of the transistor can be suppressed. That is, the transistor using the oxide semiconductor for the channel not only suppresses the manufacturing cost of the transistor, but also has excellent transistor characteristics. For example, Japanese laid-open patent publication No. 2014-146819 and Japanese laid-open patent publication No. 2015-159315 disclose transistors using an oxide semiconductor for a channel.

### SUMMARY

A display device according to embodiment of the present invention includes a display region arranged with a plurality of pixels on an insulating surface, and a terminal region with a plurality of output terminals electrically connected to the plurality of pixels in a peripheral region surrounding the display region on the insulating surface, wherein a first output terminal and a second output terminal of the plurality of output terminals are staggered, the first output terminal includes a first conductive layer, a second conductive layer, and a third conductive layer electrically connected to each other and stacked in order from the insulating surface side, the second output terminal includes a fourth conductive layer, a fifth conductive layer, and a sixth conductive layer electrically connected to each other and stacked in order from the insulating surface side, the second conductive layer has a first region extending toward the display region and functions as a first wiring, and the fourth conductive layer has a second region extending toward the display region and functions as a second wiring.

### BRIEF DESCRIPTION OF DRAWINGS

FIG. 1 is a plan view showing a configuration of a display device according to embodiment of the present invention.

FIG. 2 is a plan view showing a circuit configuration of a display device according to an embodiment of the present invention.

FIG. 3 is a schematic circuit diagram showing a configuration of a pixel circuit according to an embodiment of the present invention.

FIG. 4 is a cross-sectional view showing a cross-sectional configuration of a display device according to an embodiment of the present invention.

FIG. 5 is a schematic diagram showing a configuration of a terminal region of a display device according to an embodiment of the present invention.

FIG. 6 is a diagram showing an example of a layout of output terminals arranged in a terminal region.

FIG. 7 is a diagram showing an example of a layout of output terminals arranged in a terminal region.

FIG. 8 is a diagram showing an example of a layout of output terminals arranged in a terminal region.

FIG. 9 is a cross-sectional view of two output terminals when cut along a line A1-A2.

FIG. 10 is a cross-sectional view of two output terminals when cut along a line B1-B2.

FIG. 11 is a cross-sectional view of two output terminals when cut along a line C1-C2.

FIG. 12 is a cross-sectional view of two output terminals when cut along a line E1-E2.

FIG. 13 is a diagram showing an example of a layout of input terminals arranged in the terminal region and FPC terminals arranged in the FPC terminals region.

FIG. 14 is a cross-sectional view of two output terminals when cut along a line F1-F2.

FIG. 15 is a cross-sectional view of input terminals with a configuration partially different from that shown in FIG. 14 when cut along a line F1-F2.

### DESCRIPTION OF EMBODIMENTS

An object of an embodiment of the present invention is to provide a display device with a novel configuration that efficiently arranges signal lines electrically connected to an IC chip.

The following is a description of the invention with reference to drawings and other materials. However, the present invention can be implemented in many different aspects, and should not be construed as being limited to the description of the embodiments exemplified below. In order to make the description clearer, the drawings may be schematically represented with respect to the width, thickness, shape, and the like of each part compared with the actual embodiment, but the drawings are merely examples, and do not limit the interpretation of the present invention. In the present specification and the drawings, elements similar to those described above with respect to the above-described figures are denoted by the same reference signs (or reference signs added with a, b, and the like after numbers) and detailed description thereof may be omitted as appropriate. Furthermore, the terms “first” and “second” with respect to the respective elements are convenient signs used to distinguish the respective elements, and do not have any further meaning unless otherwise specified.

In the present specification, the expression a member or region is “above (or below)” another member or region, includes, without limitation, the case where it is directly above (or below) the other member or region, but also the case where it is above (or below) the other member or region, that is, the case where another component is included between above (or below) the other member or region.

In the present specification, a first direction D1 intersects a second direction D2 and a third direction D3 intersects the first direction D1 and the second direction D2 (D1-D2 plane). For example, the first direction D1, the second direction D2, and the third direction D3 correspond to a X direction (x direction), a Y direction (y direction), and a Z direction (z direction). The first direction D1 may be orthogonal to the second direction D2, the first direction D1 may be orthogonal to the third direction D3, and the second direction D2 may be orthogonal to the third direction D3.

In the present specification of the present application, in the case where the terms parallel, same, and match are used, errors within the scope of the design may be included in parallel, same, and match.

### 1. FIRST EMBODIMENT

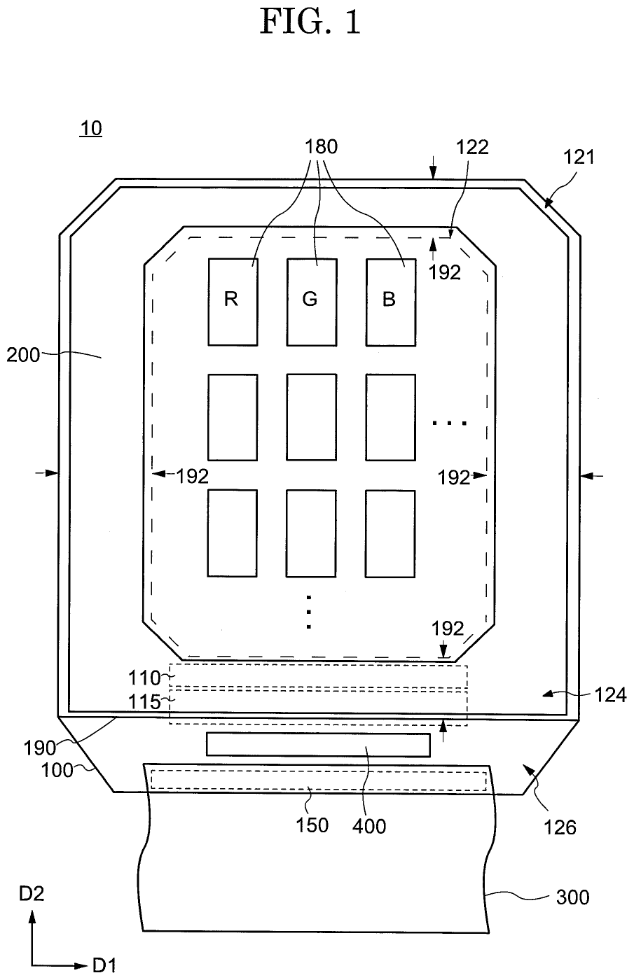

A configuration of a display device 10 will be described with reference to FIG. 1 to FIG. 15.

### 1-1. Outline of Display Device 10

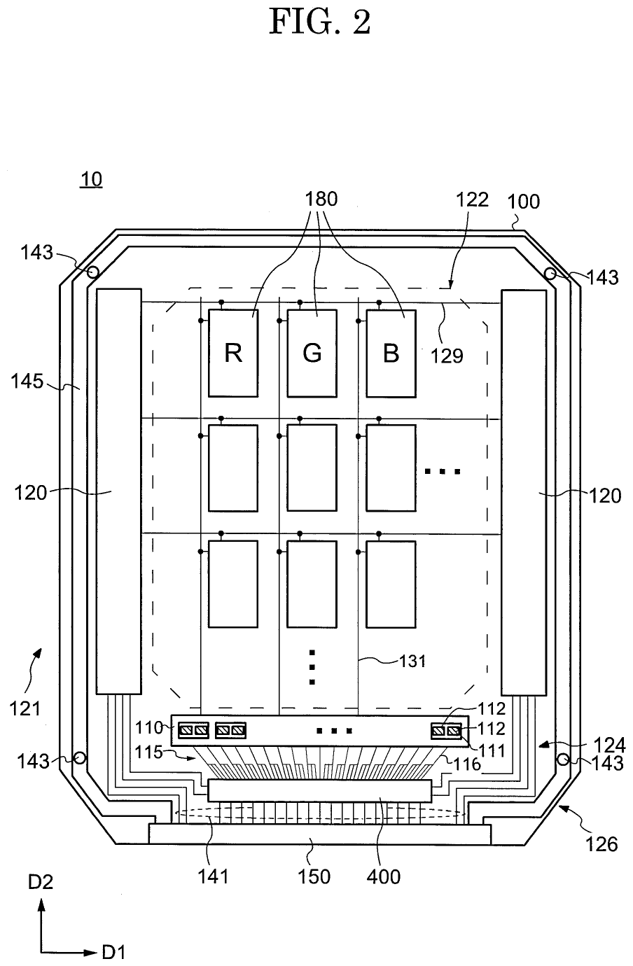

An outline of the display device 10 will be described with reference to FIG. 1 and FIG. 2. FIG. 1 is a schematic plan view showing a configuration of the display device 10. FIG. 2 is a schematic plan view showing a circuit configuration of the display device 10. For example, the display device 10 is a liquid crystal display device.

As shown in FIG. 1 or FIG. 2, the display device 10 includes an array substrate 100, a sealing part 200, a counter substrate 190, a flexible printed circuit board (FPC) 300, and an IC chip 400. The array substrate 100 and the counter substrate 190 are bonded together by the sealing part 200.

In addition, the display device 10 includes a display region 122 and a peripheral region 121 surrounding the display region 122. The peripheral region 121 includes a sealing region 124 and an exterior of the sealing region 124 surrounding the sealing region 124. The exterior of the sealing region 124 includes an exposed region 126.

A plurality of pixels 180 arranged in a matrix in the first direction D1 and the second direction D2 is arranged in the display region 122. The display region 122 is a region that overlaps a liquid crystal layer (not shown) containing liquid crystal molecules in a plan view.

A light-shielding part 192 overlapping the array substrate 100 and the counter substrate 190 is arranged in the peripheral region 121. The sealing part 200 is arranged in the sealing region 124. The sealing region 124 is a region that overlaps the sealing part 200 in a plan view.

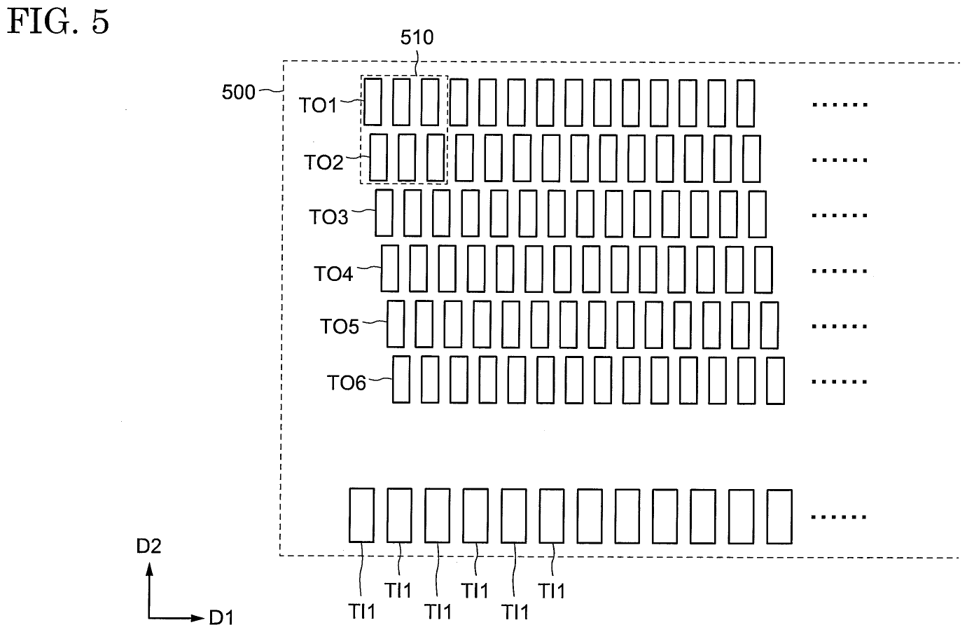

The exposed region 126 is a region where the array substrate 100 is exposed from the counter substrate 190. The FPC terminal portion 150 is located in the exposed region 126. In a plan view, the exposed region 126 is a region overlapping the FPC 300, the IC chip 400, a portion of the routing wiring section 115, and a plurality of connection terminals for connecting the IC chip 400 and the routing wiring section 115 (see FIG. 5). The plurality of connection terminals (see FIG. 5) are included in the array substrate 100 and overlap the IC chip 400 in a third direction D3.

The sealing region 124, the exterior of the sealing region 124, and the exposed region 126 may be collectively referred to as a frame region in the display device 10.

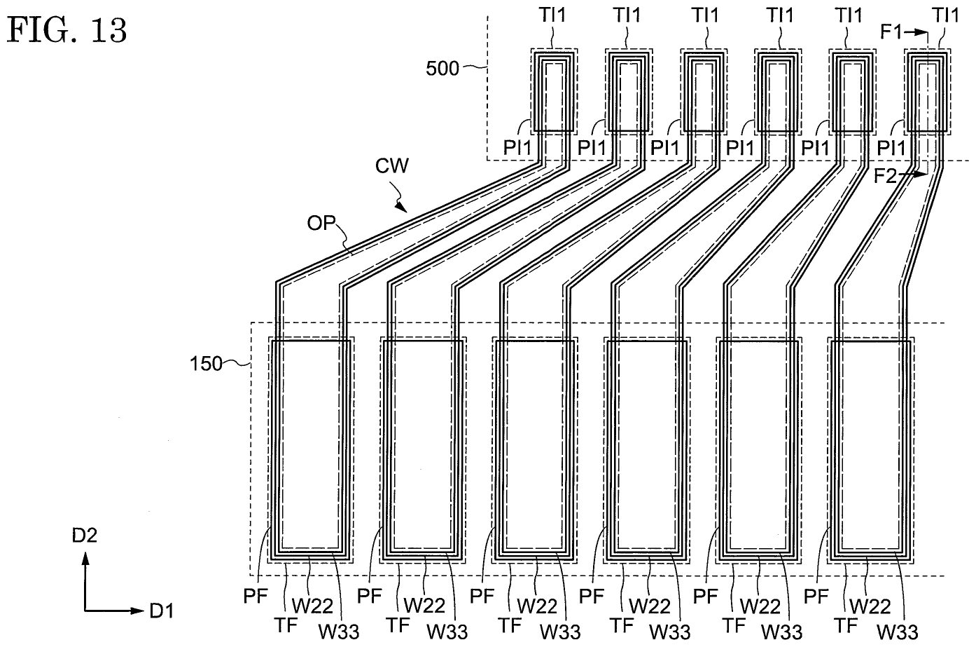

The terminal part 150 includes a plurality of FPC terminals (see FIG. 13). The routing wiring part 115 includes a plurality of data signal supply lines 116. The light-shielding part 192 overlaps the sealing part 200, a first driving circuit 110, a second driving circuit 120, part of the routing wiring part 115, and the common wiring 145, and has a function of hiding the sealing part 200, the first driving circuit 110, the second driving circuit 120, part of the routing wiring part 115, and the common wiring 145, and the like.

For example, the shape of the array substrate 100 of the display device 10 and the shape of the display region 122 are octagonal. In addition, the shape of the array substrate 100 of the display device 10 and the shape of the display region 122 are not limited to an octagon.

### 1-2. Circuit Configuration of Display Device 10

A circuit configuration of the display device 10 will be described with reference to FIG. 2. Configurations that are the same as or similar to those in FIG. 1 will be described as necessary.

As shown in FIG. 2, the FPC terminal portion 150 connected to the FPC 300 is connected to the IC chip 400 and the second driving circuit 120 by a connection wiring 141. The IC chip 400 is connected to the first driving circuit 110 using the plurality of data signal supply lines 116.

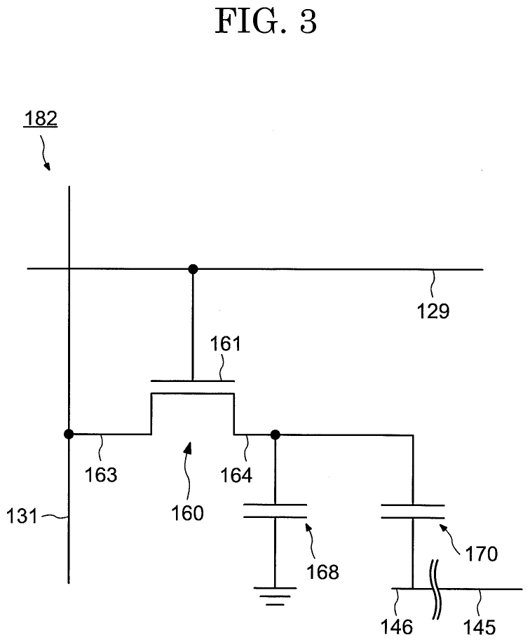

The first driving circuit 110 is arranged parallel to the direction D1 of the display region 122. The second driving circuit 120 is arranged parallel to the direction D2 of the display region 122. The first driving circuit 110 and the second driving circuit 120 overlap the sealing region 124 (FIG. 1) in a plan view. The region where the seal region 124 overlaps the first driving circuit 110 and the second driving circuit 120 is an example and is not limited to the sealing region 124 shown in FIG. 1. The region where the seal region 124 overlaps the first driving circuit 110 and the second driving circuit 120 may be a region outside the region where a pixel circuit 182 (see FIG. 3) of the plurality of pixels 180 is arranged.

For example, the first driving circuit 110 is a source driver and includes a plurality of multiplexer circuits 111 for selecting a data signal. The multiplexer circuit 111 includes a plurality of analog switches (ASW) 112. The plurality of ASWs 112 is electrically connected between a plurality of data signal lines 131 and the plurality of data signal supply lines 116, and has a function of electrically connecting the corresponding data signal line 131 and the data signal supply line 116, respectively. The number of ASWs 112 in the multiplexer circuit 111 shown in FIG. 2 is two, as an example, for convenience of explanation. The number of ASWs 112 in the multiplexer circuit 111 may be larger than two.

For example, the second driving circuit 120 is a gate driver circuit. For example, the IC chip 400 provides control signals for driving the pixel circuit 182 to at least one of the first driving circuit 110 and the second driving circuit 120.

For example, each of the plurality of pixels 180 may correspond to a sub-pixel R, a sub-pixel G, and a sub-pixel B. The pixel 180 is the smallest unit constituting part of an image reproduced in the display region 122. One display element is arranged in each pixel 180. In the example shown in FIG. 1, the display element is a liquid crystal element 170 (see FIG. 3). The color corresponding to the sub-pixel is determined by the characteristics of the liquid crystal element 170 or a color filter (not shown) arranged in the sub-pixel. In addition, the color filters may be arranged in the counter substrate 190 and may be arranged in the array substrate 100.

For example, the sub-pixel R may include a red color filter that emits red, the sub-pixel G may include a green color filter that emits green, and the sub-pixel B may include a blue color filter that emits blue.

A plurality of data signal lines including the data signal line 131 extends in the direction D2 from the first driving circuit 110 and is connected to the plurality of pixels 180 arranged in the direction D2. A plurality of scanning signal lines including a scanning signal line 129 extends in the direction D1 from the second driving circuit 120 and is connected to the plurality of pixels 180 arranged in the direction D1.

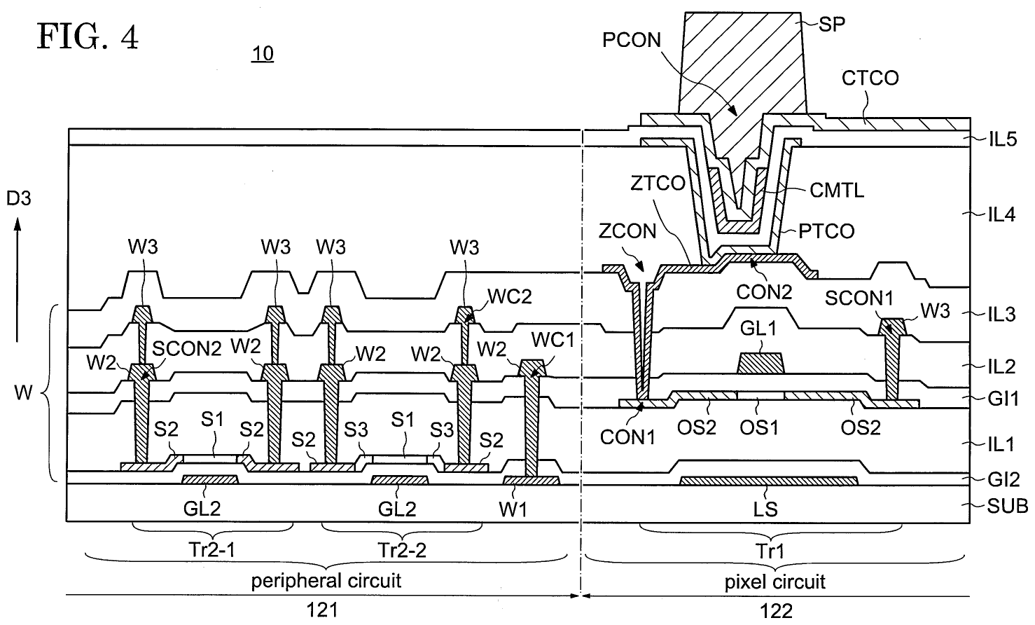

For example, the common wiring 145 overlaps the peripheral region 121 and is arranged inside the outer periphery of the peripheral region 121. A common voltage is supplied to the common wiring 145 from an external device. For example, the common voltage may be a voltage between a voltage of a positive voltage amplitude of the data signal and a voltage of a negative voltage amplitude of the data signal, and may be a voltage that is a reference of the voltage amplitude, may be 0 V, and may be a ground voltage. When the common electrode 146 (see FIG. 3) is formed on the counter substrate 190, the common wiring 145 may be electrically connected to the common electrode formed on the counter substrate 190 (not shown) via the plurality of connections 143. When the common electrode 146 is formed on the array substrate 100, the common wiring 145 may be electrically connected to the common electrode 146 (a common electrode CTCO in FIG. 4) using various wiring layers.

Since the FPC 300 is connected to the terminal part 150, the display device 10 is connected to an external device (not shown) connected to the FPC 300. For example, a signal from the external device is supplied to the IC chip 400, the first driving circuit 110, the second driving circuit 120, and each pixel 180. The display device 10 drives each pixel circuit 182 arranged in the display device 10 by using the signal from the external device and control signals generated by the IC chip 400, the first driving circuit 110, and the second driving circuit 120.

### 1-3. Configuration of Pixel Circuit 182 of Pixel 180

A configuration of the pixel circuit 182 will be described with reference to FIG. 3. FIG. 3 is a schematic circuit diagram showing a configuration of the pixel circuit 182 of the pixel 180 of the display device 10. Configurations that are the same as or similar to those in FIG. 1 and FIG. 2 will be described as necessary.

For example, the pixel circuit 182 includes a transistor 160, the liquid crystal element 170, and a capacitance element 168. Although details will be described later, for example, a first electrode of the capacitance element 168 is a pixel electrode PTCO and a second electrode of the capacitance element 168 is grounded. Similar to the capacitance element 168, a first electrode of the liquid crystal element 170 is the pixel electrode PTCO and a second electrode of the liquid crystal element 170 is a common electrode CTCO. In addition, the first electrode and the second electrode of the capacitance element 168 are interchangeable, the first electrode and the second electrode of the liquid crystal element 170 are interchangeable, and the second electrode of the liquid crystal element 170 is the common electrode 146. In addition, the second electrode of the capacitance element 168 may be the common electrode CTCO and may be the common electrode 146. The transistor 160 includes a first gate electrode 161, a first source electrode 163, and a first drain electrode 164. The first gate electrode 161 is connected to the scanning signal line 129. The first source electrode 163 is connected to the data signal line 131. The first drain electrode 164 is connected to the first electrode of the capacitance element 168 and the first electrode of the liquid crystal element 170. Furthermore, in the present specification and the drawings, for convenience of explanation, the first source electrode 163 may be referred to as a source electrode and the first drain electrode 164 may be referred to as a drain electrode, and the function as a source and the function as a drain of each electrode may be replaced by a voltage supplied (applied) to the source electrode and the drain electrode of the transistor 160.

An arbitrary signal (voltage or current) is supplied to the pixel circuit 182 of each of the three sub-pixels of the display device 10, so that the display device 10 can display an image. For example, the IC chip 400, the first driving circuit 110, the second driving circuit 120, and the external device may change the orientation status of liquid crystal molecules contained in the liquid crystal element 170 by supplying a current or a voltage to each of the pixel electrode and the common electrode 146 included in the pixel circuit 182. As a result, the display device 10 can display an image.

### 1-4. Configuration of Display Device 10

A configuration of the display device 10 will be described with reference to FIG. 4. FIG. 4 is a cross-sectional view showing a cross-sectional configuration of the display device 10. The cross-sectional view shown in FIG. 4 is a cross-sectional view for explaining a layer configuration in the cross-sectional configuration of the display device 10. The cross-sectional view shown in FIG. 4 shows a transistor Tr2 in the peripheral region 121 and a transistor Tr1 in the pixel circuit (pixel circuit) 182 adjacent to each other. In practice, the pixel circuit 182 is included in the display region 122 and the peripheral circuits are included in the peripheral region 121. Therefore, it is needless to say that the pixel circuit and the peripheral circuit shown adjacent to each other in FIG. 4 are arranged at a distance from the display device 10. In addition, the cross-sectional view shown in FIG. 4 shows the periphery of the contact hole of the pixel 180 and part of the transparent region (opening region) that contributes to the display of an image. For example, the transistor Tr2 and the transistor Tr1 are thin film transistors. Configurations that are the same as or similar to those in FIGS. 1 to 3 will be described as necessary.

As shown in FIG. 4, each layer included in the display device 10 is arranged above a substrate SUB (the third direction D3). The display device 10 includes the transistor Tr1, the transistor Tr2, a wiring group W including a plurality of wirings, a connection electrode ZTCO, the pixel electrode PTCO, a common auxiliary electrode CMTL, and the common electrode CTCO. TCO is an abbreviation for Transparent Conductive Oxide. The transistor Tr1 is a transistor included in the pixel circuit 182 of the pixel 180 of the display device 10. The transistor Tr2 is a transistor included in a peripheral circuit such as the first driving circuit 110 or the second driving circuit 120. For example, the wiring group W includes a wiring W1, a wiring W2, and a wiring W3.

### 1-4-1. Configuration of Transistor Tr1

The transistor Tr1 includes an oxide semiconductor layer OS, a gate insulating layer GI1, and a gate electrode GL1. The gate electrode GL1 faces the oxide semiconductor layer OS. The gate insulating layer GI1 is arranged between the oxide semiconductor layer OS and the gate electrode GL1. For example, the transistor Tr1 of the display device 10 is a top-gate transistor in which the oxide semiconductor layer OS is arranged closer to the substrate SUB than the gate electrode GL1. The transistor Tr1 may be a bottom-gate transistor in which the positional relationship between the gate electrode GL1 and the oxide semiconductor layer OS is reversed.

The oxide semiconductor layer OS includes oxide semiconductor layers OS1 and OS2. The oxide semiconductor layer OS1 is an oxide semiconductor layer that overlaps the gate electrode GL1 in a plan view. The oxide semiconductor layer OS1 functions as a semiconductor layer and is switched between a conductive state and a non-conductive state depending on a voltage supplied to the gate electrode GL1. That is, the oxide semiconductor layer OS1 functions as a channel of the transistor Tr1. The oxide semiconductor layer OS2 functions as a conductive layer. The oxide semiconductor layers OS1 and OS2 are layers formed from the same oxide semiconductor layer. For example, the oxide semiconductor layer OS2 is an oxide semiconductor layer from which the resistance is reduced by doping an impurity into a layer having the same physical properties as the oxide semiconductor layer OS1.

An insulating layer IL2 is arranged on the gate electrode GL1. The wiring W3 is arranged on the insulating layer IL2. The wiring W3 is connected to the oxide semiconductor layer OS2 via an opening SCON1 arranged in the insulating layer IL2 and the gate insulating layer GI1. A data signal related to a gradation of the pixel is supplied (transmitted) to the wiring W3. An insulating layer IL3 is arranged on the insulating layer IL2 and the wiring W3. The connection electrode ZTCO is provided on the insulating layer IL3. The connection electrode ZTCO is connected to the oxide semiconductor layer OS2 via an opening ZCON arranged in the insulating layers IL3 and IL2 and the gate insulating layer GI1. The connection electrode ZTCO is in contact with the oxide semiconductor layer OS2 at the bottom of the opening ZCON. The connection electrode ZTCO is a transparent conductive layer.

A region where the connection electrode ZTCO and the oxide semiconductor layer OS2 are in contact is referred to as a first contact region CON1. The connection electrode ZTCO is in contact with the oxide semiconductor layer OS2 in the first contact region CON1 that does not overlap the gate electrode GL1 and the wiring W3 in a plan view. The first contact region CON1 is included in the display region 122 in a plan view.

For example, when a transparent conductive layer such as an ITO layer is formed so as to be in contact with a semiconductor layer such as a silicon layer, a surface of the semiconductor layer is oxidized by process gases and oxygen ions at the time of a deposition of the ITO film. Since the oxide layer formed on the surface of the semiconductor layer has a high resistance, the contact resistance between the semiconductor layer and the transparent conductive layer increases. As a result, poor electrical contact occurs between the semiconductor layer and a transparent electrode layer. On the other hand, even if the transparent conductive layer is formed to be in contact with the oxide semiconductor layer, the high resistance oxide layer as described above is not formed on a surface of the oxide semiconductor layer. Therefore, no failure occurs in the electrical contact between the oxide semiconductor layer and the transparent conductive layer.

An insulating layer IL4 is arranged on the connection electrode ZTCO. The insulating layer IL4 relieves a step formed by a configuration arranged below the insulating layer IL4. The insulating layer IL4 may be referred to as a planarization film. The pixel electrode PTCO is arranged on the insulating layer IL4. The pixel electrode PTCO is connected to the connection electrode ZTCO via an opening PCON arranged in the insulating layer IL4. A region where the connection electrode ZTCO and the pixel electrode PTCO are in contact is referred to as a second contact region CON2. The second contact region CON2 overlaps the gate electrode GL1 in a plan view. The pixel electrode PTCO is a transparent conductive layer.

An insulating layer IL5 is arranged on the pixel electrode PTCO. The common auxiliary electrode CMTL and the common electrode CTCO are arranged on the insulating layer IL5. Although not shown in the figure, the common auxiliary electrode CMTL and the common electrode CTCO overlap the scanning signal line 129 and the data signal line 131 in the display region 122. For example, the common auxiliary electrode CMTL and the common electrode CTCO may be arranged in a grid pattern. The common electrode CTCO is a transparent conductive layer. The electrical resistance of the common auxiliary electrode CMTL is lower than the electrical resistance of the common electrode CTCO. In addition, the common auxiliary electrode CMTL also functions as a light-shielding layer. For example, the common auxiliary electrode CMTL blocks light from adjacent pixels, thereby suppressing the occurrence of color mixing. A spacer SP is arranged on the common electrode CTCO.

The spacer SP is arranged for some pixels. For example, the spacer SP may be arranged for any one of the sub-pixel R, the sub-pixel G, and the sub-pixel B. However, the spacer SP may be arranged for all the pixels. A height of the spacer SP is half the height of a cell gap. A spacer is also arranged in the counter substrate 190 (see FIG. 1), and the spacer of the counter substrate 190 overlaps the spacer SP in a plan view. In addition, the height of the spacer SP may be a height corresponding to the cell gap. Furthermore, as shown in FIG. 4, although the spacer SP protrudes toward the counter substrate 190 while being filled in the opening PCON, it is also possible to use a configuration in which the contact hole is only filled with a filler.

A light-shielding layer LS is arranged between the transistor Tr1 and the substrate SUB. In a plan view, the light-shielding layer LS is arranged in a region where the gate electrode GL1 and the oxide semiconductor layer OS overlap. The light-shielding layer LS suppresses light incident from the substrate SUB side from reaching the oxide semiconductor layer OS1. In the case where a conductive layer is used as the light-shielding layer LS, the oxide semiconductor layer OS1 may be controlled by applying a voltage to the light-shielding layer LS. In the case where a voltage is applied to the light-shielding layer LS, the light-shielding layer LS and the gate electrode GL1 may be connected in the peripheral region 121 of the pixel circuit 182. In a plan view, the first contact region CON1 is arranged in a region not overlapping the light-shielding layer LS.

### 1-4-2. Configuration of Transistor Tr2

The transistor Tr2 includes a p-type transistor Tr2-1 and an n-type transistor Tr2-2. In the case where the transistor Tr2 is not distinguished, the transistor included in the peripheral region 121 is expressed as the transistor Tr2. In the case where the transistor Tr2 is distinguished, the transistor Tr2 is expressed as the p-type transistor Tr2-1, the n-type transistor Tr2-2, or the like.

Both the p-type transistor Tr2-1 and the n-type transistor Tr2-2 have a gate electrode GL2, a gate insulating layer GI2, and a semiconductor layer S. The gate electrode GL2 faces the semiconductor layer S. The gate insulating layer GI2 is arranged between the semiconductor layer S and the gate electrode GL2. For example, the transistor Tr2 of the display device 10 is a bottom-gate transistor in which the gate electrode GL2 is arranged closer to the substrate SUB side than the semiconductor layer S. The transistor Tr2 may be a top-gate transistor in which the positional relationship between the semiconductor layer S and the gate electrode GL2 is reversed.

The semiconductor layer S of the p-type transistor Tr2-1 includes semiconductor layers S1 and S2. The semiconductor layer S of the n-type transistor Tr2-2 includes the semiconductor layers S1, S2, and S3. The semiconductor layer S1 is a semiconductor layer in a region overlapping the gate electrode GL2 in a plan view. The semiconductor layer S1 functions as a channel of the transistor Tr2-1. The semiconductor layer S2 functions as a conductive layer. The semiconductor layer S3 functions as a conductive layer having a higher resistance than the semiconductor layer S2. The semiconductor layer S3 suppresses hot carrier degradation by attenuating hot carriers that enter toward the semiconductor layer S1.

The insulating layer IL1 and the gate insulating layer GI1 are arranged on the semiconductor layer S. The gate insulating layer GI1 functions as an interlayer film in the transistor Tr2. The wiring W2 is arranged on these insulating layers. The wiring W2 functions as the source and drain electrodes of the transistor Tr2. The wiring W2 is connected to the semiconductor layer S via an opening WC2 arranged in the insulating layer IL1 and the gate insulating layer GI1. In addition, the wiring W2 is connected to the wiring W1 via an opening WC1 arranged in the insulating layer IL1, the gate insulating layer GI1, and the gate insulating layer GI2. The insulating layer IL2 is arranged on the wiring W2. The wiring W3 is arranged on the insulating layer IL2. The wiring W3 is connected to the wiring W2 via the opening WC2 arranged in the insulating layer IL2.

The gate electrode GL2 is formed in the same layer as the wiring W1 and the light-shielding layer LS. The wiring W2 is formed in the same layer as the gate electrode GL1. The same layer means that a plurality of members is formed by patterning one layer.

In this embodiment, the case in which the transistors Tr2-1 and Tr-2 are bottom-gate transistors is described. The transistors Tr2-1 and Tr2-2 may be top-gate transistors. In this case, a base layer may be provided on the substrate SUB. The semiconductor layer S is preferably provided on the base layer. The gate insulating layer GI2 is provided over the semiconductor layer S. The gate electrode GL2 and the wiring W1 are provided over the gate insulating layer GI2. An insulating layer IL1 is provided above the gate electrode GL2 and the wiring W1. The wiring W2 provided above the insulating layer IL1 is connected to the wiring W1 through the aperture WC1 provided in the insulating layer IL1 and the gate insulating layer GI1. The light-shielding layer LS of the transistor Tr1 is provided on the same layer as the gate electrode GL2, and is therefore provided between the gate insulating layer GI2 and the insulating layer IL1. The layer configuration above the insulating layer IL1 is the same as in FIG. 4.

### 1-4-3. Materials of Each Member of Display Device 10

A rigid substrate having light transmittance and having no flexibility, such as a glass substrate, a quartz substrate, or a sapphire substrate, can be used as the substrate SUB. On the other hand, in the case where the substrate SUB needs to have flexibility, a flexible substrate containing a resin and having flexibility, such as a polyimide substrate, an acrylic substrate, a siloxane substrate, or a fluororesin substrate, can be used as the substrate SUB. In order to improve the heat resistance of the substrate SUB, an impurity may be introduced into the resin.

A metal material can be used as the gate electrodes GL1 and GL2, the wirings W1, W2, and W3, the light-shielding layer LS, and the common auxiliary electrode CMTL. For example, aluminum (Al), titanium (Ti), chromium (Cr), cobalt (Co), nickel (Ni), molybdenum (Mo), hafnium (Hf), tantalum (Ta), tungsten (W), bismuth (Bi), or silver (Ag), or an alloy or compound thereof is used as the metal material. The above-described metal material may be used in a single layer or in a stacked layer as the members of the electrode or the like.

For example, a stacked configuration of Ti/Al/Ti is used as the gate electrode GL1. In the present embodiment, a cross-sectional shape of a pattern end of the gate electrode GL1 having the stacked configuration is a forward tapered shape.

Common insulating materials can be used as the gate insulating layers GI1 and GI2 and the insulating layers IL1 to IL5. For example, an inorganic insulating layer such as silicon oxide (SiOₓ), silicon oxynitride (SiOₓN_{y}), silicon nitride (SiNₓ), silicon nitride oxide (SiNₓO_{y}), aluminum oxide (AlOₓ), aluminum oxynitride (AlOₓN_{y}), aluminum nitride oxide (AlNₓO_{y}), or aluminum nitride (AlNₓ) can be used as the gate insulating layers GI1 GI2, and the insulating layers IL1 to IL3, and IL5. An insulating layer with few defects can be used as these insulating layers. An organic insulating material such as a polyimide resin, an acryl resin, an epoxy resin, a silicone resin, a fluororesin, or a siloxane resin can be used as the insulating layer IL4. The above-described organic insulating material may be used as the gate insulating layers GI1 and GI2 and the insulating layers IL1 to IL3, and IL5. The above-described insulating material may be used in a single layer or in a stacked layer as the members of the insulating layer or the like.

SiOₓ having a thickness of 100 nm is used as the gate insulating layer GI1 as an example of the insulating layer described above. SiOₓ/SiNₓ/SiOₓ having a total thickness of 600 nm to 700 nm is used as the insulating layer IL1. SiOₓ/SiNₓ having a total thickness of 60 nm to 100 nm is used as the gate insulating layer GI2. SiOₓ/SiNₓ/SiOₓ having a total thickness of 300 nm to 500 nm is used as the insulating layer IL2. SiOₓ (single layer), SiNₓ (single layer), or a stack thereof having a total thickness of 200 nm to 500 nm is used as the insulating layer IL3. An organic layer having a thickness of 2 μm to 4 μm is used as the insulating layer IL4. SiNₓ (single layer) having a thickness of 50 nm to 150 nm is used as the insulating layer IL5.

SiOₓN_{y} and AlOₓN_{y} are a silicon compound and an aluminum compound containing a smaller proportion (x>y) of nitrogen (N) than oxygen (O). SiNₓO_{y} and AlNₓO_{y} are a silicon compound and an aluminum compound containing a smaller proportion (x>y) of oxygen than nitrogen.

An oxide semiconductor having semiconductor characteristics can be used as the oxide semiconductor layer OS. The oxide semiconductor layer OS has light transmittance. For example, an oxide semiconductor containing indium (In), gallium (Ga), zinc (Zn), and oxygen (O) can be used. In particular, an oxide semiconductor having a composition ratio of In:Ga:Zn:O=1:1:1:4 can be used. However, the oxide semiconductor containing In, Ga, Zn, and O used in the present embodiment is not limited to the above-described composition, and an oxide semiconductor having a composition other than the above can also be used. The material forming the oxide semiconductor layer OS may be referred to as a second material.

A material having semiconductor characteristics can be used as the semiconductor layer S. For example, a material forming the semiconductor layer S is polysilicon. The material forming the semiconductor layer S may be referred to as a first material.

A transparent conductive layer is used as the connection electrode ZTCO, the pixel electrode PTCO, and the common electrode CTCO. A mixture of indium oxide and tin oxide (ITO) or a mixture of indium oxide and zinc oxide (IZO) can be used as the transparent conductive layer. A material other than the above may be used as the transparent conductive layer.

For example, a material forming the sealing part 200 may be a thermosetting resin or a UV (Ultra Violet) curable resin.

In conventional display devices for smartphones, output terminals connected to the IC chip for supplying various signals to the display region are arranged in one or two rows. In contrast, in a display device for head-mounted displays, since a higher resolution is desired more than in conventional display devices, the number of output terminals connected to the IC chip also further increases. However, since a width of the IC chip (a length in the first direction D1) is determined by a panel size of the display device, it is necessary to efficiently place a plurality of output terminals within the predetermined region where the IC chip is placed. Even if the plurality of output terminals can be placed within the predetermined region, the number of wirings extending from each of the plurality of output terminals will also increase. Therefore, when three or more rows of output terminals are placed within the predetermined region, the width and spacing (pitch) of the wiring extending from the output terminals becomes smaller. When the width and spacing of the wiring becomes smaller, it may be difficult to process when forming the wiring in the manufacturing process of the display device. In addition, when the width and spacing of the wiring is to be secured, the width of the output terminals must be reduced. This may make it difficult to check the connection (indentation) by conductive particles of an anisotropic conductive film (ACF) when connecting the output terminal to the IC chip. This can easily result in a poor connection between the output terminal and the IC chip.

One of the purposes of this invention is to provide the display device 10 with a novel configuration in which signal lines are efficiently arranged.

### 1-4-4. Terminal Region of IC Chip

The terminal region of the display device according to an embodiment of the present invention will be described in detail with reference to FIG. 5 to FIG. 12. FIG. 5 is a schematic diagram showing a configuration of a terminal region 500 of a display device according to an embodiment of the present invention. In FIG. 5, the terminal region 500 where the IC chip 400 is located is indicated by a dotted line.

Output terminals TO1 to TO6 and an input terminal TI1, which are connected to the IC chip 400 to supply various signals to the display region 122, are located in the terminal region 500. The output terminal TO1 represents the output terminal located in a first row. Similarly, the output terminals TO2 to TO6 each represent output terminals located on a second row to sixth row, respectively. The output terminals TO1 to TO6 are arranged along a direction between the first direction D1 and the second direction D2 for the convenience of extending wiring from each of the output terminals TO1 to TO6. In this specification and others, even if the arrangement of the output terminals TO1 to TO6 deviates from the second direction D2 by several degrees, they may be described as being arranged along the second direction D2 for the sake of explanation. In this specification and others, when there is no particular limitation on the row or the column in which the output terminals TO1 to TO6 are arranged, they are simply described as an output terminal TO. In this embodiment, the case in which the plurality of output terminals arranged in the terminal region 500 is six rows is described, but is not limited to this configuration. The number of output terminals TO should be set appropriately according to the number of pixels (rows of pixels) arranged in the display region 122. For example, when the display device 10 is for VR applications, the number of output terminals TO should be at least three rows.

The output terminals TO1 to TO6 are arranged in a staggered arrangement. Here, the staggered arrangement (staggered array) means that the plurality of output terminals arranged in a certain row are placed between a predetermined pitch of a plurality of output terminals arranged in an adjacent row. For example, in the first row, the output terminal TO2 in the second row is placed between adjacent output terminals TO1 and TO1. Similarly, in the second row, the output terminal TO3 in the third row is placed between adjacent output terminals TO2 and TO2, and the output terminals TO3 to TO6 in the third and subsequent rows are placed in the same manner.

The input terminal TI1 on the first row is located in the terminal region 500. The input terminal TI1 is electrically connected to the FPC terminal (not shown). In this specification and others, when there is no particular limitation on the row or column in which the input terminal TI1 is located, it is simply referred to as the input terminal TI. In this embodiment, the case in which the plurality of input terminals TI arranged in the terminal region 500 is one row is described, but is not limited to this configuration. The number of input terminals TI may be set appropriately according to the number of FPC terminals arranged in the FPC terminal region.

In FIG. 5, only the input terminal TI1 and the output terminals TO1 to TO6 are shown in the terminal region 500, and the wiring is omitted. First, the arrangement and configuration of the output terminals TO1 to TO6 are described. The wirings extending from each of the two output terminals adjacent to each other in the second direction D2 (also called lead-out wirings) are provided on different layers. In the following description, the planar layout of the output terminals and the lead-out wiring will be explained.

### 1-4-5. Configuration of Output Terminal and Wiring

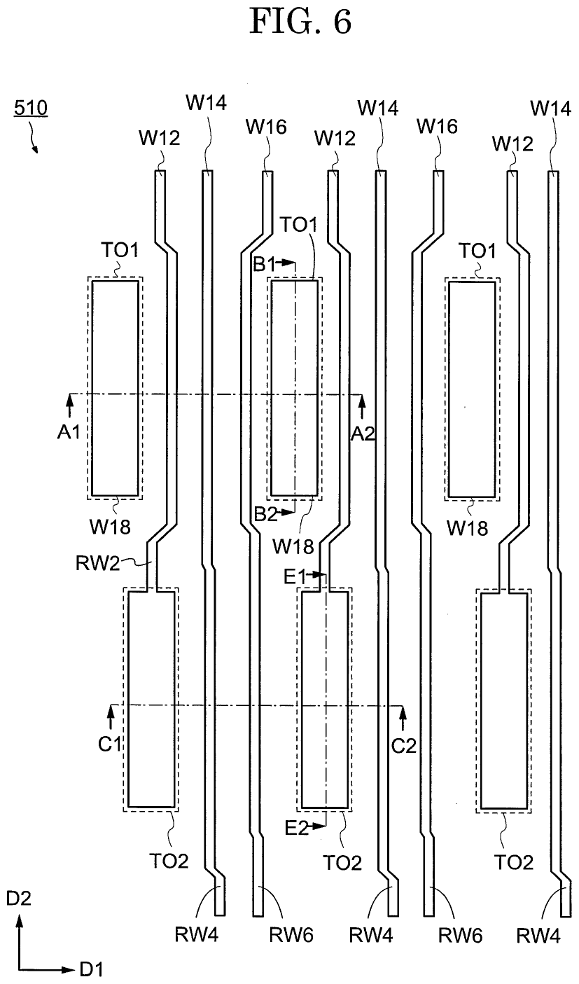

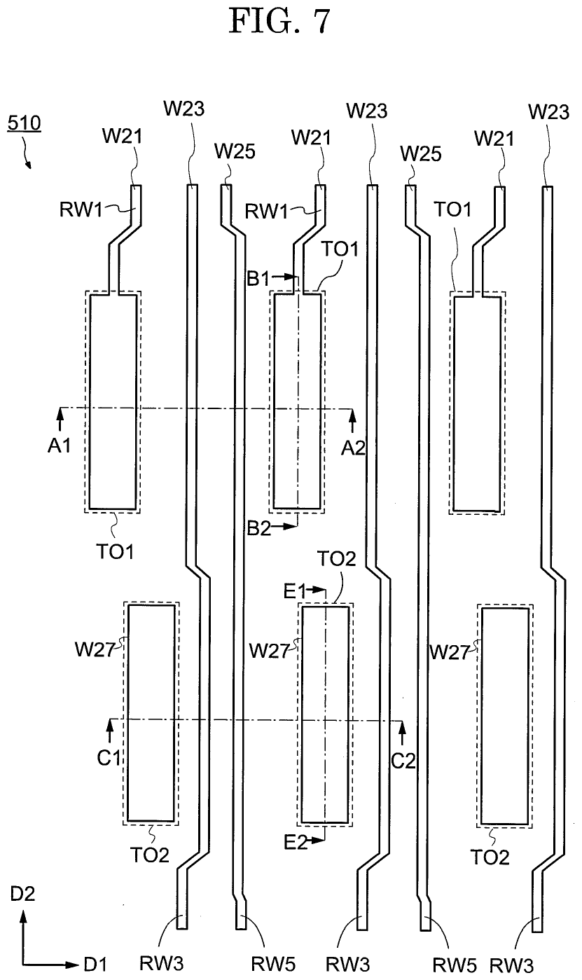

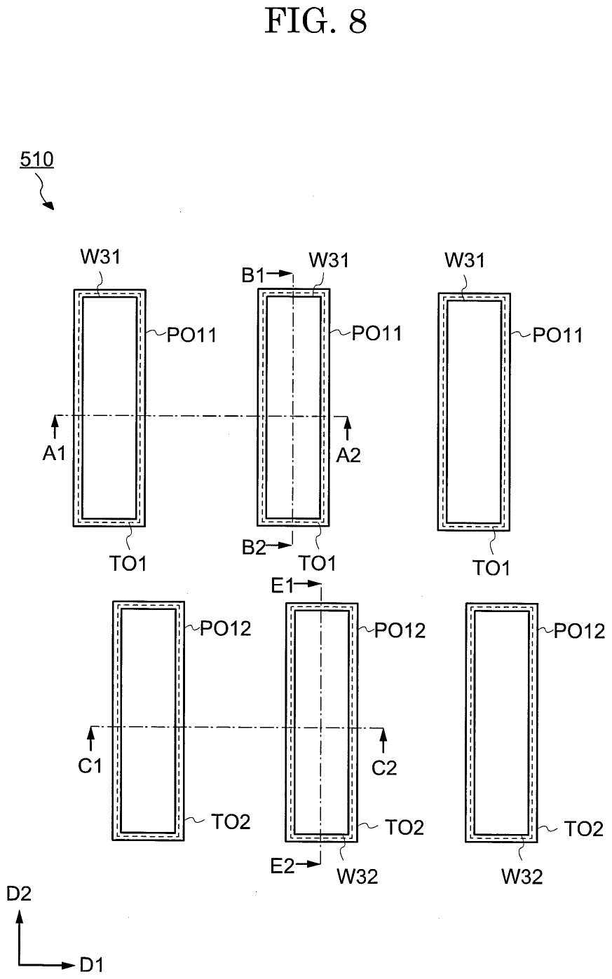

FIG. 6 to FIG. 8 show an enlarged view of the terminal region 510 where the output terminals TO1 and TO2 are located in the terminal region 500. FIG. 6 to FIG. 8 show an example layout of the output terminals TO1 and TO2 located in the terminal region 500. In FIG. 6 to FIG. 8, the regions where the output terminals TO1 and TO2 are located are indicated by dotted lines. FIG. 6 shows a plan view of conductive layers W12, W14, W16, and W18, which are provided on the same layer as the gate electrode GL2 and the wiring W1 (see FIG. 4). FIG. 7 shows a plan view of conductive layers W21, W23, W25, and W27, which are provided on the same layer as the gate electrode GL1 and the wiring W2 (see FIG. 4). FIG. 8 shows conductive layers W31 and W32 provided on the same layer as the wiring W3 (see FIG. 4) and transparent conductive layers PO11 and PO12 provided on the same layer as the connecting electrode ZTCO (see FIG. 4).

As shown in FIG. 6, the conductive layer W12 has a wiring RW2 extending toward the display region 122, and the output terminal TO2. Of the conductive layers comprising the output terminal TO, the wiring extending toward the display region 122 is also referred to as the lead-out wiring. The conductive layer W14 has the output terminal TO4 (not shown) and a wiring RW4 extending from the output terminal TO4 toward the display region 122. The conductive layer W16 has the output terminal TO6 (not shown) and a wiring RW6 extending from the output terminal TO6 toward the display region 122. The conductive layer W18 is located in the region where the output terminal TO1 is provided and is electrically connected to the output terminal TO1. The conductive layer W18 has an island shape, and no wiring extends from the conductive layer W18.

As shown in FIG. 7, the conductive layer W21 has the wiring RW1 extending toward the display region 122, and the output terminal TO1. The conductive layer W23 has the output terminal TO3 (not shown) and the wiring RW3 extending from the output terminal TO3 toward the display region 122. The conductive layer W25 has the output terminal TO5 (not shown) and the wiring RW5 extending from the output terminal TO5 toward the display region 122. The conductive layer W27 is located in the region where the output terminal TO2 is provided. The conductive layer W27 has an island shape and no wiring extends from the conductive layer W27.

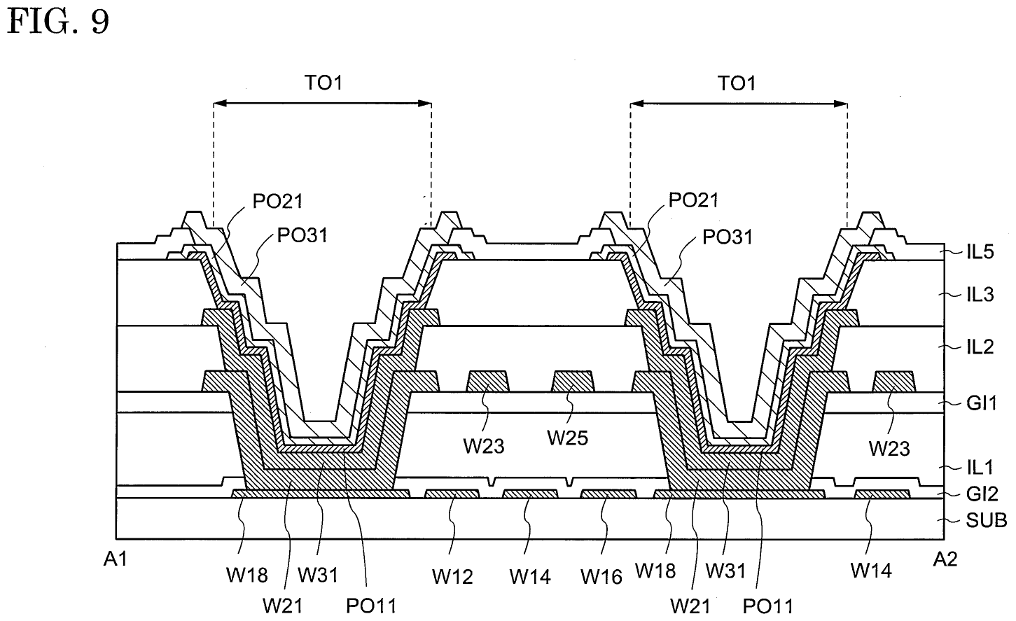

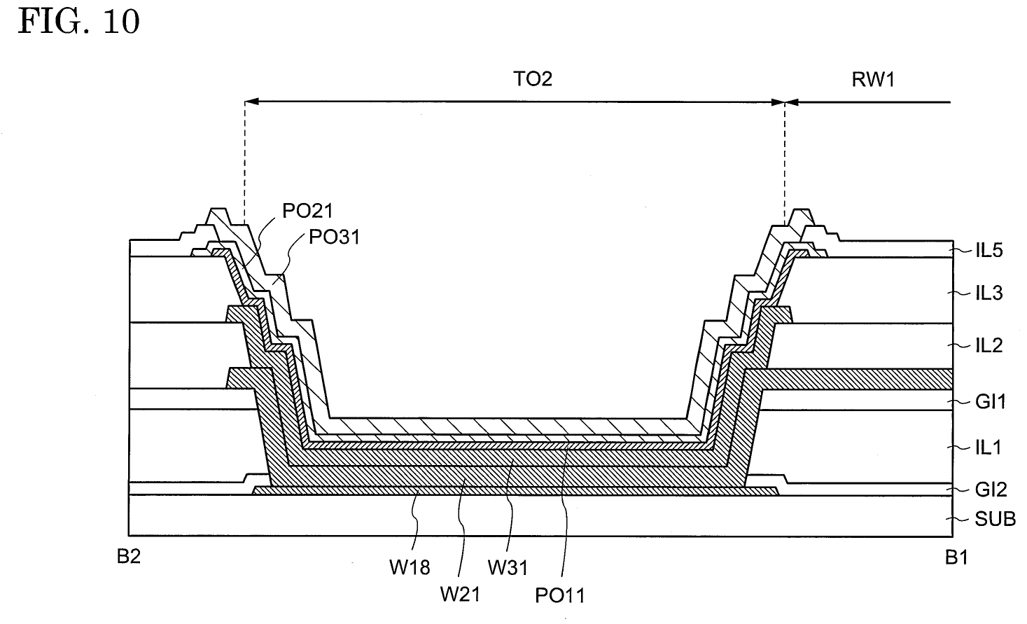

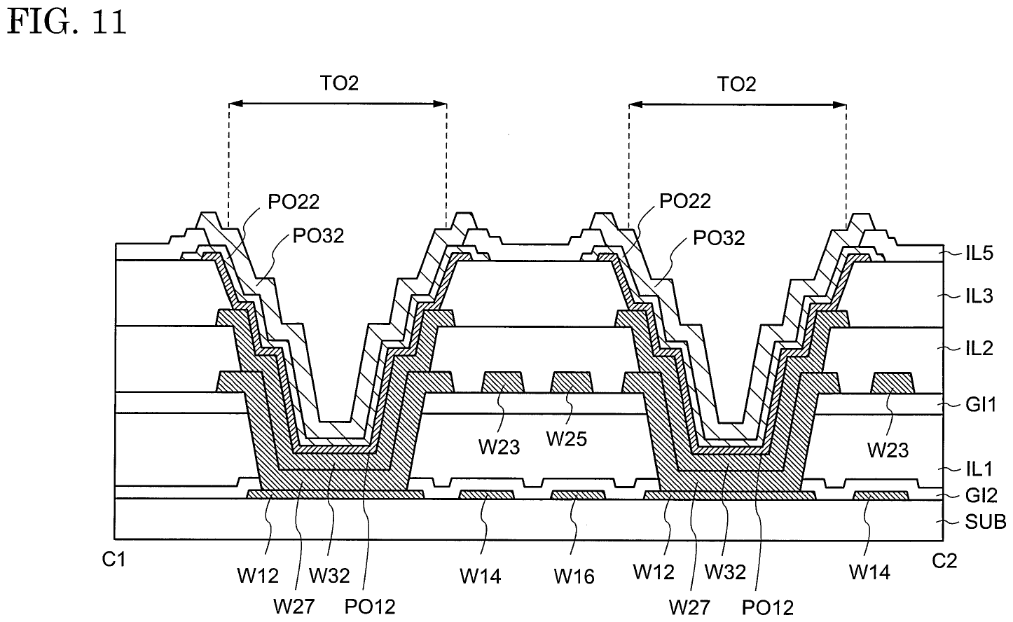

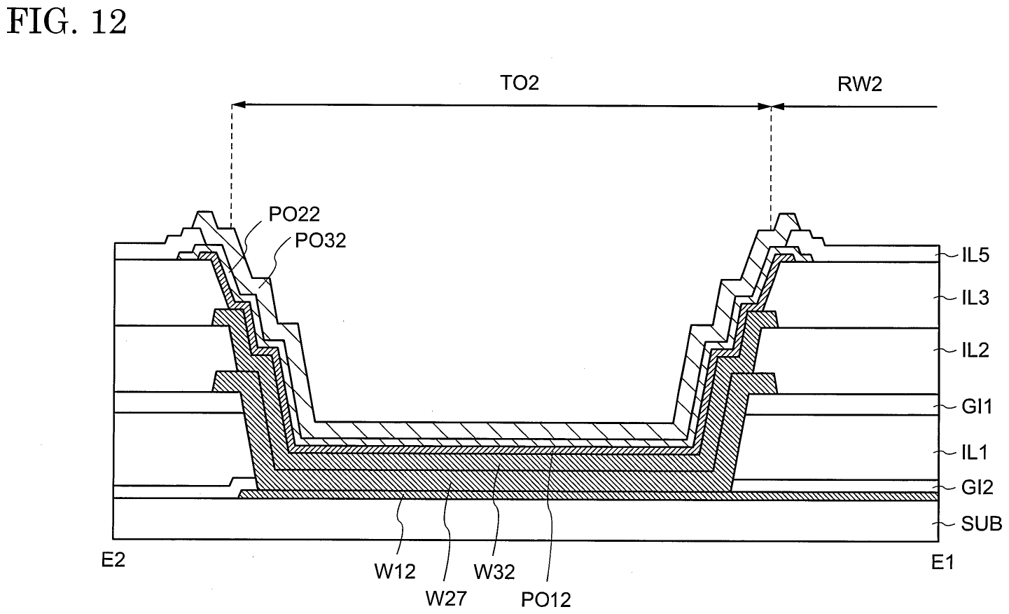

As shown in FIG. 8, the conductive layer W31 has a region that constitutes the output terminal TO1. The conductive layer W32 has a region that constitutes the output terminal TO2. The transparent conductive layer PO11 is a pad that constitutes the output terminal TO1, and the transparent conductive layer PO12 is a pad that constitutes the output terminal TO2. The output terminals TO1 to TO6 further have transparent conductive layers PO21 and PO22 (see FIG. 9 and FIG. 10), which are provided on the same layer as the pixel electrode PTCO, and transparent conductive layers PO31 and PO32 (see FIG. 11 and FIG. 12), which are provided on the same layer as the common electrode CTCO, but are not shown in FIG. 8. The layout of the transparent conductive layers PO21, PO22 and the transparent conductive layers PO31, PO32 is generally the same as that of the transparent conductive layer PO1.

Next, the cross-sectional configurations at the output terminals TO1 and TO2 shown in FIG. 6 to FIG. 8 are explained with reference to FIG. 9 to FIG. 12. FIG. 9 shows a cross-sectional view of the two output terminals TO1 when cut along a line A1-A2. FIG. 10 is a cross-sectional view of the output terminal TO1 when cut along a line B1-B2 line. FIG. 11 is a cross-sectional view of the two output terminals TO2 when cut along a line C1-C2. FIG. 12 is a cross-sectional view of the output terminal TO2 when cut along a line E1-E2. In the terminal region 500, the insulating layer IL4, which functions as a planarization film, may be removed. In FIG. 6 to FIG. 8, the configuration in which the insulating layer IL4 is removed is described.

First, the cross-sectional configuration of the output terminal TO1 is described. As shown in FIG. 9 and FIG. 10, the output terminal TO1 is composed of the conductive layer W18, the conductive layer W21 on the gate insulating layer GI1, the conductive layer W31, the transparent conductive layer PO11, the transparent conductive layer PO21, and the transparent conductive layer PO31. In FIG. 10, the region of the conductive layer W21 that functions as a lead-out wiring is shown as the wiring RW1. The conductive layer W21 is connected to the conductive layer W31 via an opening in the insulating layer IL2. The transparent conductive layer PO11 is connected to the conductive layer W31 via an opening in the insulating layer IL3. The transparent conductive layer PO21 is provided in contact with the transparent conductive layer PO11 so as to cover the transparent conductive layer PO11. The transparent conductive layer PO31 is connected to the transparent conductive layer PO21 via an opening in the insulating layer IL5.

The stacked configuration of the output terminal TO1 has been described above, and the same applies to the stacked configuration of the output terminals TO3 to TO6. The wirings RW1, RW3, and RW5 extending from each of the output terminals TO1, TO3, and TO5 are provided on the gate insulating layer GI1. The wirings RW2, RW4, and RW6 extending from each of the output terminals TO2, TO4, and TO6, as described below, are formed by the same layer of the wiring W1 provided between the substrate SUB and the insulating layer IL1 as shown in FIG. 6 and FIG. 12. The wirings are formed by the same layer as the wiring W1 between the substrate SUB and the insulating layer IL1 as shown in FIG. 6 and FIG. 12. Thus, although there are five wirings provided between two adjacent output terminals TO1, three wirings are provided on the same layer as the conductive layer W18 and two wirings are provided on the same layer as the conductive layer W21. In other words, the wiring density provided on the same layer can be smaller. This allows the width of each of the plurality of wirings to be larger than in the case of five wirings on the same layer. Since the wiring density between the two output terminals TO1 can be reduced, the widths of the conductive layers W18 and W21, which correspond to the width of the output terminal TO1, can also be increased. This makes it easier to check the connection (indentation) by the conductive particles of the anisotropic conductive film when connecting the output terminal to the IC chip. Therefore, it is possible to suppress the occurrence of connection defects between the output terminal and the IC chip.

The output terminal TO1 and the output terminal TO2 are composed of the same number of conductive layers, although the layers where the lead-out wiring is located are different. Therefore, a height of a surface of the transparent conductive layer PO31 of the output terminal TO1 and a height of the transparent conductive layer PO32 of the output terminal TO2 can be generally the same in the two output terminals TO1 and TO2 adjacent to each other in the second direction D2. The surface irregularities formed by the output terminals TO1 and TO2 can be mitigated. This can mitigate the surface irregularities in the terminal region 500, thereby suppressing connection failures between the IC chip 400 and the output terminals TO1 to TO6.

In this embodiment, in the region where the output terminals TO1 and TO2 are formed, each of the insulating layers IL3 and IL5 is opened instead of forming the transparent conductive layer PO31 after opening the insulating layers IL3 and IL5 collectively. In this case, it is preferable to provide the transparent conductive layers PO11 and PO21 when opening the insulating layer IL3 and when opening the insulating layer IL5, in order to prevent damage to the surface of an underlying layer caused by etching.

Next, the cross-sectional configuration of the output terminal TO2 will be described. As shown in FIG. 11 and FIG. 12, the output terminal TO2 is composed of the conductive layer W12, the conductive layer W27, the conductive layer W32, the transparent conductive layer PO12, the transparent conductive layer PO22, and the transparent conductive layer PO32 on the substrate SUB. In FIG. 12, a region of the conductive layer W12 that functions as a lead-out wiring is shown as the wiring RW2. The conductive layer W27 is connected to the conductive layer W12 via an opening in the gate insulating layer GI1, the insulating layer IL1, and the gate insulating layer GI2. The conductive layer W32 is connected to the conductive layer W27 via an opening in the insulating layer IL2. The transparent conductive layer PO12 is connected to the conductive layer W32 via an opening in the insulating layer IL3. The transparent conductive layer PO22 is provided in contact with the transparent conductive layer PO12 so as to cover the transparent conductive layer PO12. The transparent conductive layer PO32 is connected to the transparent conductive layer PO22 via an opening provided in the insulating layer IL5.

The conductive layers W14 and W16 are provided as a wiring between two adjacent conductive layers W12. In addition, the conductive layers W23 and W25 are provided as wiring between the two adjacent conductive layers W27. In other words, when viewed in a plan view, the two adjacent wirings are provided on different insulating layers. Thus, although there are four wirings provided between two adjacent output terminals TO2, the two wirings are provided on the same layer as the conductive layer W12 and the two wirings are provided on the same layer as the conductive layer W27. In other words, the wiring density on the same layer can be smaller. This allows the width of each of the plurality of wirings to be larger than in the case of four wirings on the same layer. Since the wiring density between the two output terminals TO2 can be reduced, the width of the conductive layer W12 and the conductive layer W27, which correspond to the width of the output terminal TO2, can also be increased.

The cross-sectional configurations of the output terminals TO1 and TO2 have been described in detail above. The output terminals TO3 and TO5 have the same configuration as the output terminal TO1, and the output terminals TO4 and TO6 have the same configuration as the output terminal TO2. Therefore, for the configurations of the output terminals TO4 to TO6, refer to the respective descriptions of the output terminals TO1 and TO2.

In a display device, when a plurality of output terminals connected to an IC chip for supplying various signals to the display region are arranged in six rows along the second direction D2, the wiring density on the display region side is high. For example, when the wiring extending from each of the output terminals TO2 to TO6 is provided on the same layer, five wirings will be provided between the output terminals TO1 and TO1. Therefore, it is necessary to reduce the width and spacing of the wiring extending from each of the output terminals TO1 to TO6. In order to secure the width and spacing of the wiring, the width of each of the output terminals TO1 to TO6 must be reduced. This may result in poor wiring processing and poor connection between the output terminals and the IC chip in the manufacturing process of the display device.

In contrast, in the display device 10 according to an embodiment of the present invention, for the output terminals TO1 to TO6 arranged along the second direction D2, each of the wiring extending from the two adjacent output terminals TO is arranged on a different insulating layer. This allows the wiring density between the two adjacent output terminals TO along the first direction D1 to be reduced. In particular, the wiring density at the output terminal TO1, which is located on the display region 122 side, can be reduced. Therefore, even if the number of pixels in the display device 10 is increased, the width of the lead-out wiring extending from the terminal region 500 to the display region 122 and the width of the output terminal TO can be secured. This can suppress wiring processing defects in the manufacturing process of the display device 10. In addition, connection defects when connecting the output terminals TO1 to TO6 to the IC chip 400 can be suppressed.

In the output terminals TO1 to TO6, each of the two adjacent output terminals has a lead-out wiring on a different layer, but the number of conductive layers comprising the output terminals TO1 to TO6 is the same. This allows the surface irregularities of the staggered output terminals TO1 to TO6 to be mitigated. It can also suppress a poor connection between the IC chip 400 and the output terminals TO1 to TO6 caused by the surface irregularities of the terminal region 500.

### 1-4-6. Configuration of Input Terminal, Wiring, and FPC Terminal

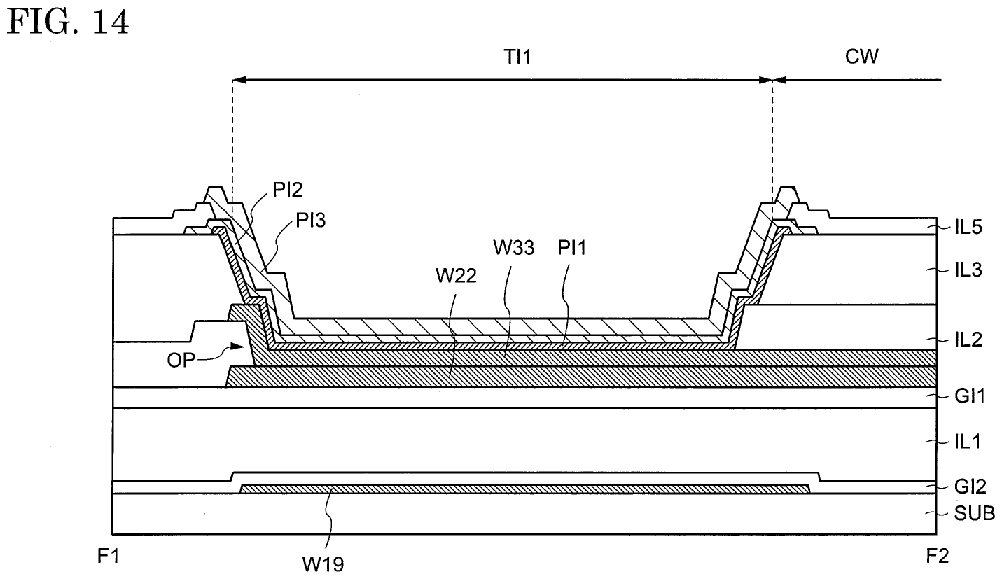

Next, an arrangement and configuration of the input terminals TI1 are described with reference to FIG. 13 and FIG. 14. FIG. 13 is a planar layout of the input terminals TI located in the terminal region 500 and FPC terminals TF connected to each of the input terminals TI1. FIG. 14 is a cross-sectional view of the input terminal TI1 shown in FIG. 13 when cut along a line F1-F2.

As shown in FIG. 13, the plurality of input terminals TI1 is arranged in a single row in the terminal region 500. In this embodiment, an example of a plurality of input terminals TI1 arranged in a single row is described, but this embodiment is not limited to this. The input terminals TI may be arranged in a plurality of rows. When the input terminals TI are arranged in a plurality of rows, it is preferable to arrange them in a staggered manner.

As shown in FIG. 13, the input terminal TI1 consists of the conductive layer W22, the conductive layer W33, and a transparent conductive layer PI1. In addition, the plurality of FPC terminals TF is located in the FPC terminal portion 150. The FPC terminals TF are composed of a conductive layer W22, a conductive layer W33, and a transparent conductive layer PF. The conductive layer W22 is provided on the same layer as the gate electrode GL1 and the wiring W2 (see FIG. 4). The conductive layer W33 is provided on the same layer as the wiring W3 (see FIG. 4).

The transparent conductive layer PI1 and the transparent conductive layer PF layer are provided on the same layer as the connection electrode ZTCO. The transparent conductive layer PI1 is a pad that constitutes the input terminal TI1. The transparent conductive layer PF is a pad that constitutes the FPC terminal TF.

The input terminal TI1 also has a transparent conductive layer PI2 (see FIG. 14), which is provided on the same layer as the pixel electrode PTCO, and a transparent conductive layer PI3 (see FIG. 14), which is provided on the same layer as the common electrode CTCO, but are not shown in FIG. 13. The layout of the transparent conductive layer PI2 and the transparent conductive layer PI3 is generally the same as that of the transparent conductive layer PI1. The conductive layer W22 and the conductive layer W33 are in contact via the opening OP formed in the insulating layer IL2. In other words, the conductive layers W22 and W33, which constitute the input terminal TI1, extend to the FPC terminal 150 in contact with each other to constitute the FPC terminal TF.

Next, the cross-sectional configuration of the input terminal TI1 will be described. As shown in FIG. 14, the input terminal TI1 is composed of the conductive layer W22, the conductive layer W33, the transparent conductive layer PI1, the transparent conductive layer PI2, and the transparent conductive layer PI3 on the gate insulating layer GI1. In FIG. 14, a region of the conductive layer W22 and the conductive layer W33 that functions as the connection wiring connecting with the FPC terminal TF is shown as the connection wiring CW. The conductive layer W22 is connected to the conductive layer W33 through the opening OP in the insulating layer IL2. The transparent conductive layer PI1 is connected to the conductive layer W33 via an opening in the insulating layer IL3. The transparent conductive layer PI2 is provided in contact with the transparent conductive layer PI1 so as to cover the transparent conductive layer PI1. The transparent conductive layer PI3 is connected to the transparent conductive layer PI2 via an opening provided in the insulating layer IL5.

In the input terminal TI1, a conductive layer W19 is provided in a region overlapping the conductive layer W22 via the gate insulating layer GI1, the insulating layer IL1, and the gate insulating layer GI2. The conductive layer W19 is provided between the substrate SUB and the gate insulating layer GI2. When the transistors T2-1 and T2-2 are of the top gate configuration, the conductive layer W19 is provided between the gate insulating layer GI2 and the insulating layer IL1. By providing the conductive layer W19 in a region overlapping the input terminal TI1, surface irregularities formed by a height of a surface of the transparent conductive layer PI3 and a height of a surface of the topmost transparent conductive layer of the output terminal TO in the input terminal TI1 and the output terminals TO1 to TO6 can be mitigated. As a result, the surface irregularities in the terminal region 500 can be mitigated, and the connection defects between the IC chip 400 and the input terminal TI1 can be suppressed.

The cross-sectional configuration of the FPC terminal TF may be the same as that of the input terminal TI1 shown in FIG. 14. Therefore, similar to the input terminal TI1, the FPC terminal TF may also have two more transparent conductive layers on the transparent conductive layer PF. In the case of two more transparent conductive layers on the transparent conductive layer PF, they should be arranged in the same way as the layout of the transparent conductive layer PF. In the FPC terminal FT, the conductive layer provided under the conductive layer W22 may be omitted.

The configuration of the wiring extending from the output terminal TO and the input terminal TI1 are different. The output terminal TO uses a region extending from a conductive layer located on the same layer as the gate electrode GL1 or a region extending from a conductive layer located on the same layer as the gate electrode GL2 as a lead-out wiring. In contrast, the wiring extending out from the input terminal TI1 is used as the connection wiring CW with the conductive layer located on the same layer as the gate electrode GL1 and the conductive layer located on the same layer as the wiring W3 in contact. This makes it possible to further reduce the wiring resistance of the connecting wiring CW that connects the input terminal TI to the FPC terminal FT.

Although the example of stacking three transparent conductive layers as a pad at the output terminal TO and the input terminal TI has been described, one embodiment of the present invention is not limited to this. One transparent conductive layer or two transparent conductive layers may be used as a pad. However, in order to suppress a poor connection between the output terminal TO and the input terminal TI and the IC chip 400, the number of layers of the transparent conductive layers used as pads should be the same for the output terminal TO and the input terminal TI.

In this embodiment, the case in which the stacked configuration of the input terminal TI1 is different from that of the output terminal TO1 is described. The stacked configuration of the input terminal TI1 may be the same as that of the output terminal TO1.

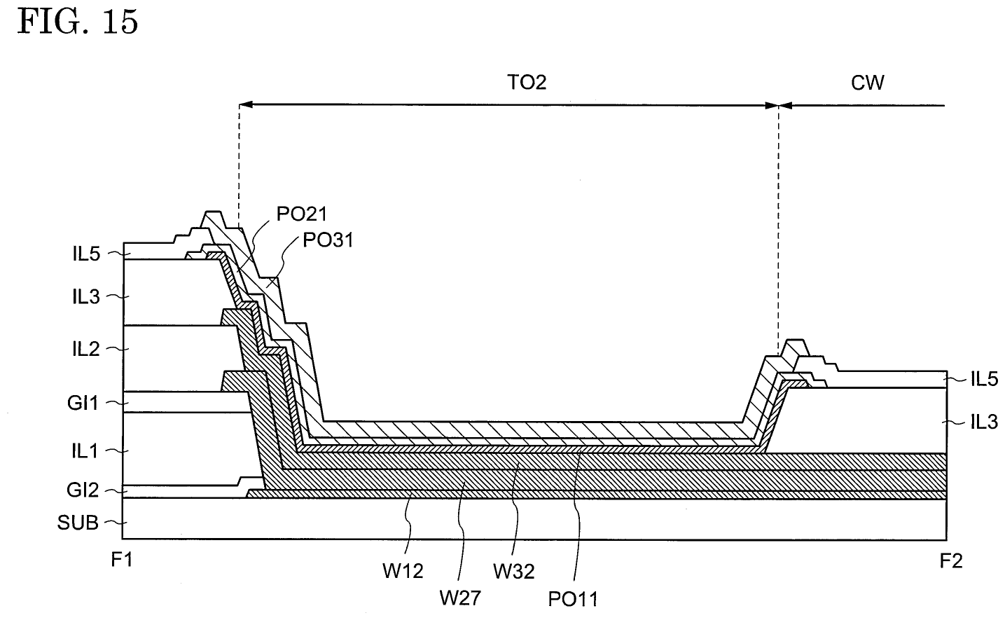

FIG. 15 is a cross-sectional view of the input terminal TI with a configuration partially different from that of the input terminal TI1 shown in FIG. 14 when cut along a line F1-F2. The number of conductive layers to be stacked is different between the connection wiring CW extending from the input terminal TI1 shown in FIG. 15 and the input terminal TI1 shown in FIG. 14. As shown in FIG. 15, three conductive layers may be used as the connecting wiring CW, and the FPC terminal TP may be configured using three conductive layers in the same manner as the connecting wiring CW.

Although not shown in the figure, an inspection circuit may be provided in the terminal region 500 or in the vicinity of the terminal region 500. When an inspection circuit is provided in the terminal region 500 or in the vicinity of the terminal region 500, the lead-out wiring may be extended from the output terminal TO to the input terminal TI. In this embodiment, each of the lead-out wiring from the two adjacent output terminals TO along the second direction D2 is located on a different layer. Therefore, the density of wiring extending from the output terminals TO1 to TO6 can be reduced even when the inspection circuitry connected to the output terminals TO is arranged.

Various configurations exemplified as an embodiment of the present invention can be appropriately combined and implemented as long as no contradiction is caused. In addition, various configurations exemplified as an embodiment of the present invention can be appropriately replaced as long as no contradiction is caused. The addition, deletion, or design change of components, or the addition, deletion, or condition change of processes as appropriate by those skilled in the art based on the display device disclosed in the present specification and the drawings are also included in the scope of the present invention as long as they are provided with the gist of the present invention.

Further, it is understood that, even if the effect is different from those provided by each of the above-described embodiments, the effect obvious from the description in the specification or easily predicted by persons ordinarily skilled in the art is apparently derived from the present invention.

What is claimed is:

1. A display device comprising:
a display region arranged with a plurality of pixels on an insulating surface; and
a terminal region with a plurality of output terminals electrically connected to the plurality of pixels in a peripheral region surrounding the display region on the insulating surface,
wherein
a first output terminal and a second output terminal of the plurality of output terminals are staggered,
the first output terminal includes a first conductive layer, a second conductive layer, and a third conductive layer electrically connected to each other and stacked in order from the insulating surface side,
the second output terminal includes a fourth conductive layer, a fifth conductive layer, and a sixth conductive layer electrically connected to each other and stacked in order from the insulating surface side,
the second conductive layer has a first region extending toward the display region and functions as a first wiring, and
the fourth conductive layer has a second region extending toward the display region and functions as a second wiring.

2. The display device according to claim 1, wherein
the first output terminal has at least two transparent conductive layers electrically connected to the third conductive layer,
the second output terminal has at least two transparent conductive layers electrically connected to the sixth conductive layer, and
the number of layers of the transparent conductive layers included in the first output terminal is the same as the number of layers of the transparent conductive layers included in the second output terminal.

3. The display device according to claim 1, wherein
the terminal region further includes a plurality of input terminals,
the input terminals are composed of a seventh conductive layer and an eighth conductive layer electrically connected to each other on a first insulating layer provided above the first conductive layer and the fourth conductive layer in order from the insulating surface side, and
a ninth conductive layer overlapping the seventh conductive layer and electrically insulated from the seventh conductive layer is provided between the insulating surface and the first insulating layer.

4. The display device according to claim 3, wherein
the first output terminal has at least two transparent conductive layers electrically connected to the third conductive layer,
the input terminal has at least two transparent conductive layers electrically connected to the eighth conductive layer, and
the number of layers of the transparent conductive layers included in the first output terminal is the same as the number of layers of the transparent conductive layers included in the input terminal.

5. The display device according to claim 3, wherein
the seventh conductive layer and the eighth conductive layer constitute an FPC terminal electrically connected to the input terminal.

6. The display device according to claim 1, wherein
the terminal region further has a plurality of input terminals, and
the input terminal has a seventh conductive layer, an eighth conductive layer, and a ninth conductive layer electrically connected to each other in order from the insulating surface side.

7. The display device according to claim 6, wherein
the first output terminal has at least two transparent conductive layers electrically connected to the third conductive layer,
the input terminal has at least two transparent conductive layers electrically connected to the ninth conductive layer, and
the number of layers of the transparent conductive layers included in the first output terminal is the same as the number of layers of the transparent conductive layers included in the second output terminal.

8. The display device according to claim 6, wherein
the seventh conductive layer, the eighth conductive layer, and the ninth conductive layer constitute an FPC terminal electrically connected to the input terminal.

9. The display device according to claim 1, wherein
the pixel has a first transistor including a first gate electrode, a first insulating layer, an oxide semiconductor layer, a first source electrode, and a first drain electrode,
the first gate electrode is provided on the same layer as the second conductive layer, and
the first source electrode is provided on the same layer as the third conductive layer.

10. The display device according to claim 9, wherein
the first drain electrode is provided above the first source electrode, and
the first drain electrode is formed by a first transparent conductive layer.

11. The display device according to claim 10, wherein
the pixel has a planarization film provided above the first drain electrode, and
the pixel further has a pixel electrode connected to the first drain electrode via an opening in the planarization film.

12. The display device according to claim 9, wherein
the first transistor further includes a light-shielding layer and a second insulating layer provided between the insulating surface and the oxide semiconductor layer, and
the light-shielding layer faces the first gate electrode with the second insulating layer and the oxide semiconductor layer in between.

13. The display device according to claim 1, wherein
the peripheral region further includes a driving circuit provided in the peripheral region,
the driving circuit has a second transistor including a second gate wiring, a second insulating layer, a semiconductor layer, a second source electrode, and a second drain electrode,
the second gate wiring is provided between the insulating surface and the second insulating layer, and
the second source electrode and the second drain electrode are provided on the same layer as the second conductive layer.
